(19) United States
(12) Patent Application Publication
(10) Pub. No.: US 2025/0333866 A1
(43) Pub. Date: Oct. 30, 2025

(54) CONDUCTIVE COBALT-BASED METAL-ORGANIC FRAMEWORK-BASED ELECTRODE FOR OXYGEN GENERATION

(71) Applicant: KING FAHD UNIVERSITY OF PETROLEUM AND MINERALS, Dhahran (SA)

(72) Inventors: Aasif HELAL, Dhahran (SA); Munzir SULIMAN, Dhahran (SA); Lolwah Tawfiq ALFUHAID, Dhahran (SA)

(73) Assignee: KING FAHD UNIVERSITY OF PETROLEUM AND MINERALS, Dhahran (SA)

(21) Appl. No.: 18/648,092

(22) Filed: Apr. 26, 2024

(51) Int. Cl. C25B 11/095; C07F 15/06; C25B 1/04; C25B 11/052; C25B 11/065

(52) U.S. Cl. CPC C25B 11/095; C07F 15/065; C25B 1/04; C25B 11/052; C25B 11/065

(57) ABSTRACT

A method of oxygen evolution includes contacting a working electrode comprising a metal-organic framework in a synthetic polymer on a conductive carbon paper, a counter electrode, and a reference electrode with an aqueous solution, applying a potential, and producing oxygen at the working electrode in the form of bubbles. The metal-organic framework includes cobalt and reacted units of benzene-1,3,5-tricarboxylic acid in a weight ratio from 1:1 to 1:5.

### STATEMENT REGARDING PRIOR DISCLOSURE BY THE INVENTORS

Aspects of the present disclosure are described in Helal, A., et al., “Efficient oxygen evolution using conductive cobalt-based metal-organic framework” published in Fuel, Volume 363, 131044, which is incorporated herein by reference in its entirety.

### STATEMENT OF ACKNOWLEDGEMENT

Support provided by the Saudi Aramco-sponsored Chair Program on Carbon Capture and Utilization through Grant ORCP2390 is gratefully acknowledged.

### BACKGROUND

### Technical Field

The present disclosure is directed to a metal-organic framework, and more particularly, directed to a method of oxygen evolution using a conductive cobalt-based metal-organic framework-based electrode.

### Description of Related Art

The “background” description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present claims.

The demand for renewable has increased, and electrochemical energy conversion and storage technology is a promising clean and sustainable energy technology. Recently, effort has been expended on developing various rechargeable and convertible energy storage and conversion systems. The development of electrochemical storage energy and conversion energy technology is represented in electrochemical energy storage devices by lithium-ion batteries (LIBs), zinc-ion batteries (ZIBs), lithium-sulfur batteries (LI-S), and supercapacitors (SCs), as well as electrocatalytic energy conversion by the CO₂ reduction reaction (CO₂RR), hydrogen evolution reaction (HER), oxygen reduction reaction (ORR), and oxygen evolution reaction (OER). Creating successful electrochemical energy conversion and storage systems require careful design and preparation of electrocatalysts and electrode materials with advantageous qualities.

Metal-organic frameworks (MOFs) are a promising class of materials for energy storage and conversion applications that have recently gained attention. Metal-organic frameworks (MOFs) are hybrid crystalline porous materials prepared by binding between a metal center (cluster) and organic ligands (linkers, e.g., carboxylates and azolates or N-containing compounds). MOFs exhibit unique physical and chemical properties, such as high crystallinity, high specific area, large internal pore volume, periodic structures, strong metal-ligand interactions, high adsorption, and high porosity, which are tunable properties. MOFs are thought to be more effective and more commonly used materials than activated carbon and zeolites. MOF materials have been used in various applications such as electrochemical applications, renewable energy, gas storage, separation, adsorption, and drug delivery. MOFs have received extensive attention for energy storage and conversion applications due to their tunable properties.

BTB (benzene-1,3,5-tricarboxylic acid) is a popular organic ligand in MOF production. It is a flexible ligand that may produce a variety of MOF structures with varying pore sizes and shapes. BTB is a linear tricarboxylic acid that can form a MOF structure when combined with metal ions. Cobalt ions have been used to prepare various Co-BTB MOFs used in multiple applications, such as electrodes in supercapacitors. Other readily available metal ions, such as iron, nickel, manganese, and vanadium ions, have been used in MOFs as electrocatalysts.

The decreasing cost of electricity generated from renewable sources is drawing attention to the potential of producing hydrogen by water electrolysis. This process not only provides a feasible alternative for converting and storing renewable energy but also offers promising prospects for the future; however, various difficulties still need to be addressed in relation to manufacturing cost, safety, storage, infrastructure, and other related factors.

An underlying justification for utilizing renewable energy sources in the process of electrolysis is to effectively store excess electrical energy by converting it into hydrogen gas (H₂). The conversion of electrical energy into hydrogen gas (H₂) using water electrolysis presents prospects due to the well-established markets for H₂, which are thought to further increase in the future. The expense associated with electricity constitutes a large component in the total expenditure of production. To tackle the overpotential difficulty, the need exists to develop electrocatalysts that are both cost-effective and possess high activity and stability. These electrocatalysts help facilitate half-reactions of the electrolyzer.

To reduce the obstacle of overpotential, commercially available proton exchange membrane (PEM) electrolyzer may be outfitted with an electrode composed of platinum (Pt) and iridium (Ir) metals; however, the expense and the restricted availability of these metals are considered a big obstacle to the production of electrolyzers with high capacity and their deployment. As a result of the high cost and scarcity of platinum and iridium, a diverse range of electrocatalysts, including chalcogenides, perovskite solids, phosphates, oxides, hydroxides, carbides, and phosphides, have been used as alternatives.

Although several materials have been developed for energy storage and conversion applications, conventional materials and/or methods involve multiple steps and are not cost-effective or readily available. This results in electrolyzers with low capacity and non-extensive deployment. Accordingly, an object of the present disclosure is to develop a simple and efficient method of generating oxygen using an electrocatalyst that overcome the limitations of known methods of generating oxygen.

### SUMMARY

In an exemplary embodiment, a method of oxygen evolution is described. The method includes contacting a working electrode, a counter electrode, and a reference electrode with an aqueous solution. The working electrode is a metal-organic framework in a synthetic polymer on a conductive carbon paper. The metal-organic framework includes cobalt and reacted units of benzene-1,3,5-tricarboxylic acid. A molar ratio of the cobalt to the reacted units of the benzene-1,3,5-tricarboxylic acid is from 1:1 to 1:5. The working electrode, the counter electrode, and the reference electrode are in connection with a potentiostat. The method includes applying a potential from 1.0 to 2.0 volts (V) vs. RHE. The method includes producing oxygen at the working electrode in the form of bubbles.

In some embodiments, the metal-organic framework is in the form of agglomerated hexagonal sheet-like layers.

In some embodiments, the agglomerated hexagonal sheet-like layers are in bunches of 5 to 500 individual hexagonal sheets.

In some embodiments, in the individual hexagonal sheets have the longest dimension of 0.5 to 5 micrometers (μm).

In some embodiments, the metal-organic framework is made by a process includes mixing a cobalt salt, a benzene-1,3,5-tricarboxylic acid, an amide, and a polar protic acid to form a solution. The process includes sonicating the solution for 2 to 10 minutes. The process further includes heating the solution at a temperature of 150 to 200° C. for 20 to 30 hours to form the metal-organic framework. Finally, the process includes washing and drying the metal-organic framework.

In some embodiments, the metal-organic framework has a thermal stability of 280 to 320° C., as measured by thermal gravimetric analysis (TGA).

In some embodiments, a surface area of the conductive carbon paper is 0.5 to 1.5 square centimeter (cm²).

In some embodiments, a volume of 50 to 150 microliters (μL) of the metal-organic framework in the synthetic polymer in a polar solvent is deposited on the surface area of the conductive carbon paper.

In some embodiments, the metal-organic framework in the synthetic polymer in the polar solvent are drop-cast on the conductive carbon paper.

In some embodiments, the synthetic polymer is a sulfonated tetrafluoroethylene polymer.

In some embodiments, the counter electrode is a graphite rod.

In some embodiments, the reference electrode is a saturated silver-silver chloride electrode.

In some embodiments, the aqueous solution is a basic potassium salt solution.

In some embodiments, the working electrode has a current density of 100 to 150 milliamperes square centimeters (mA cm⁻²) at a potential of 1.8 V vs. RHE.

In some embodiments, the working electrode has a Tafel slope of 40 to 50 millivolts per decade (mV dec⁻¹).

In some embodiments, the working electrode has a current density of 18 to 25 mA cm⁻² after applying a continuous potential for 16 to 24 hours.

In some embodiments, the working electrode has a double layer capacitance of 1 to 2 millifarads square centimeter (mF cm⁻²).

In some embodiments, the working electrode has a charge transfer resistance of 1 to 3 ohm (Ω) determined from a Nyquist plot.

In some embodiments, the Nyquist plot has a secondary semicircle.

In some embodiments, the secondary semicircle has a charge transfer resistance of 0.5 to 1.5Ω.

These are other aspects of the non-limiting embodiments of the present disclosure will become apparent to those skilled in the art upon review of the following description of specific non-limiting embodiments of the disclosure in conjunction with the accompanying drawings. The foregoing general description of the illustrative present disclosure and the following detailed description thereof are merely exemplary aspects of the teachings of this disclosure and are not restrictive.

### BRIEF DESCRIPTION OF THE DRAWINGS

A more complete appreciation of this disclosure (including alternative and/or variations thereof) and many of the attendant advantages thereof may be readily obtained as the same becomes better understood by reference to the following detailed description when considered in connection with the accompanying drawings, wherein:

FIG. 1A is a flow chart depicting a method of oxygen evolution, according to certain embodiments;

FIG. 1B is a flow chart depicting a process of making a metal-organic framework, according to certain embodiments;

FIG. 2 depicts a powdered X-ray diffraction (PXRD) pattern of a cobalt benzene-1,3,5-tricarboxylic acid (Co-BTB) metal-organic framework (MOF), according to certain embodiments;

FIG. 3 depicts a Fourier-transform infrared (FTIR) spectrum of the Co-BTB, according to certain embodiments;

FIG. 4 depicts a thermogravimetric analysis (TGA) plot of the Co-BTB, according to certain embodiments;

FIGS. 5A-5B depict scanning electron microscope (SEM) images of the Co-BTB, at different magnifications, according to certain embodiments;

FIG. 6A depicts linear sweep voltametric (LSV) curves of IrO₂, Co₂O₃, and Co-BTB, according to certain embodiments;

FIG. 6B depicts Tafel slopes of IrO₂, Co₂O₃, and Co-BTB, according to certain embodiments;

FIG. 6C depicts stability of the Co-BTB, according to certain embodiments;

FIG. 7A depicts cyclic voltammograms (CV) of the Co-BTB, at various scan speeds, according to certain embodiments;

FIG. 7B depicts CVs of the Co₂O₃, at various scan speeds, according to certain embodiments;

FIG. 7C depicts double layer capacitance (C_{dl}) values of the Co₂O₃ and the Co-BTB, according to certain embodiments;

FIG. 7D depicts electrochemical impedance spectroscopy (EIS) of the Co₂O₃ and the Co-BTB in the form of a Nyquist plot, according to certain embodiments; and

FIG. 7E depicts a Nyquist plot of the Co-BTB, according to certain embodiments.

### DETAILED DESCRIPTION

In the following description, it is understood that other embodiments may be utilized, and structural and operational changes may be made without departure from the scope of the present embodiments disclosed herein.

Reference will now be made to specific embodiments or features, examples of which are illustrated in the accompanying drawings. In the drawings, whenever possible, corresponding or similar reference numerals will be used to designate identical or corresponding parts throughout the several views. Moreover, references to various elements described herein are made collectively or individually when there may be more than one element of the same type. However, such references are merely exemplary in nature. It may be noted that any reference to elements in the singular may also be constructed to relate to the plural and vice-versa without limiting the scope of the disclosure to the exact number or type of such elements unless set forth explicitly in the appended claims. Further, as used herein, the words “a,” “an,” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

As used herein, the words “a” and “an” and the like carry the meaning of “one or more.” Within the description of this disclosure, where a numerical limit or range is stated, the endpoints are included unless stated otherwise. Also, all values and subranges within a numerical limit or range are specifically included as if explicitly written out.

As used herein “metal-organic frameworks” or “MOFs” are a class of porous polymer compounds having a lattice structure made from (i) a cluster of metal ions as vertices (“cornerstones”) (“secondary building units” or “SBUs”) linked together by (ii) organic linkers. The metal ion clusters coordinate to the organic linkers to form one-, two-, and three-dimensional structures. The cluster of metal ions are metal-based inorganic groups, for example metal oxides and/or hydroxides. The linkers are usually at least bidentate ligands, which coordinate to the metal-based inorganic groups via functional groups such as carboxylates and/or amines. MOFs are considered coordination polymers made up of (i) the metal ion clusters and (ii) organic linker building blocks.

In the formation of a metal-organic framework, the organic ligands may meet requirements to form coordination bonds, such as being multi-dentate, having at least two donor atoms (i.e., N—, and/or O—), and being neutral or anionic. The structure of the metal-organic framework is also affected by the shape, length, and functional groups present in the organic linker. In certain embodiments, the metal-organic framework may include anionic ligands as organic ligands. In one or more embodiments, the organic ligands may have at least two nitrogen donor atoms. For example, the organic ligands may be imidazolate-based, imidazole-derived, or ligands similar to an imidazole including, but not limited to, optionally substituted imidazoles, optionally substituted benzimidazoles, optionally substituted imidazolines, optionally substituted pyrazoles, optionally substituted thiazoles, optionally substituted triazoles, and the like.

In some embodiments, the metal-organic frameworks may include, but are not limited to, isoreticular metal organic framework-3 (IRMOF-3), MOF-69A, MOF-69B, MOF-69C, MOF-70, MOF-71, MOF-73, MOF-74, MOF-75, MOF-76, MOF-77, MOF-78, MOF-79, MOF-80, DMOF-1-NH2, UMCM-1-NH2, MOF-69-80, ZIF-1, ZIF-2, ZIF-3, ZIF-4, ZIF-5, ZIF-6, ZIF-7, ZIF-8, ZIF-9, ZIF-10, ZIF-11, ZIF-12, ZIF-14, ZIF-20, ZIF-21, ZIF-22, ZIF-23, ZIF-25, ZIF-60, ZIF-61, ZIF-62, ZIF-63, ZIF-64, ZIF-65, ZIF-66, ZIF-67, ZIF-68, ZIF-69, ZIF-70, ZIF-71, ZIF-72, ZIF-73, ZIF-74, ZIF-75, ZIF-76, ZIF-77, ZIF-78, ZIF-79, ZIF-80, ZIF-81, ZIF-82, ZIF-90, ZIF-91, ZIF-92, ZIF-93, ZIF-94, ZIF-96, ZIF-97, ZIF-100, ZIF-108, ZIF-303, ZIF-360, ZIF-365, ZIF-376, ZIF-386, ZIF-408, ZIF-410, ZIF-412, ZIF-413, ZIF-414, ZIF-486, ZIF-516, ZIF-586, ZIF-615, ZIF-725, the like, and a combination thereof.

Aspects of the present disclosure are directed to efficient oxygen evolution using a metal-organic framework, and more particularly, using a conductive cobalt-based metal-organic framework as a component of an electrocatalyst and/or electrode.

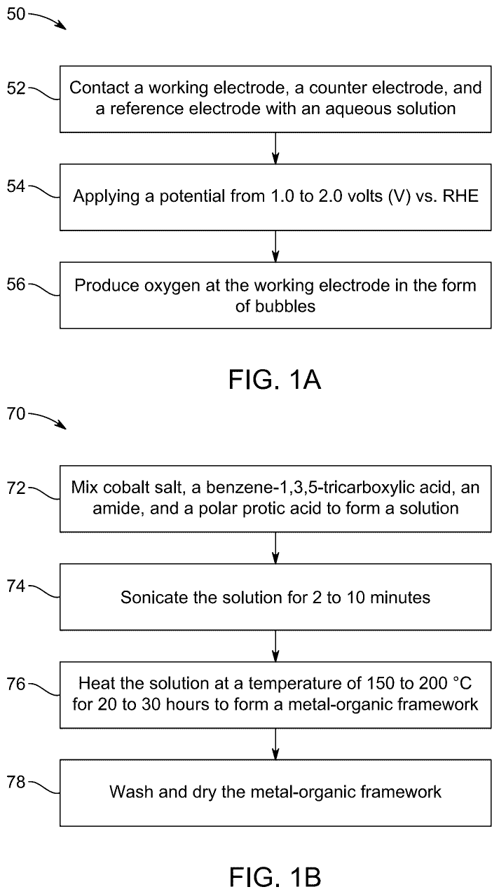

FIG. 1A illustrates a flow chart of a method 50 of oxygen evolution. The order in which the method 50 is described is not intended to be construed as a limitation, and any number of the described method steps can be combined in any order to implement the method 50. Additionally, individual steps may be removed or skipped from the method 50 without departing from the spirit and scope of the present disclosure.

At step 52, the method 50 includes contacting a working electrode, a counter electrode, and a reference electrode with an aqueous solution. As used herein, “working electrode” refers to the electrode in an electrochemical cell/device/sensor on which the electrochemical reaction of interest is occurring. The working electrode is a metal-organic framework in a synthetic polymer on a conductive carbon paper. The metal-organic framework includes cobalt and reacted units of benzene-1,3,5-tricarboxylic acid. A weight ratio of the cobalt to the reacted units of the benzene-1,3,5-tricarboxylic acid is from 1:1 to 1:5, preferably 1:1 to 3:1, preferably 1:2 to 2:1, and more preferably about 3:2. In some embodiments, the metal-organic framework is in the form of agglomerated hexagonal sheet-like layers. In some embodiments, the agglomerated hexagonal sheet-like layers are in bunches of 5 to 500, preferably 10 to 450, preferably 20 to 400, preferably 50 to 350, more preferably 100 to 300, and yet more preferably 150 to 250 individual hexagonal sheets. In some embodiments, the individual hexagonal sheets have a longest dimension of 0.5 to 5 micrometers (μm), preferably 1 to 3 μm, more preferably 1.5 to 2.5 μm, and yet more preferably about 2 μm. In some embodiments, the geometry of the metal-organic framework may be circular, polygonal, triangular, rectangular, square, cuboidal, the like, and a combination thereof. The metal-organic framework has a thermal stability of 280 to 320° C., as measured by thermogravimetric analysis (TGA).

The working electrode further includes a synthetic polymer. The synthetic polymer serves as a binder that binds the metal-organic framework to the conductive carbon paper. Suitable examples of synthetic polymers include, but are not limited to, poly(diallyl amine), diallyl ketone, diallyl amine, styryl sulfonate, vinyl lactam, laponite, polygorskites (such as attapulgite, sepiolite), polyethylenes, polyesters, tetrafluoroethylenes, fluoropolymers, the like, and combinations thereof. In some embodiments, the synthetic polymer is a sulfonated tetrafluoroethylene polymer. In an embodiment, a mass of 5 to 15 milligrams (mg), preferably 7 to 12 mg, and more preferably about 10 mg, of the metal-organic framework is suspended in a polar solvent. Suitable examples of the polar solvents include, but are not limited to, acetone, acetonitrile, dimethylformamide (DMF), dimelthylsulfoxide (DMSO), isopropanol, water, methanol, the like, and a combination thereof. In a preferred embodiment, the polar solvent is isopropanol and water. In an embodiment, a volume of 20 to 100 microliters (μL), preferably 30 to 70 μL, more preferably 40 to 60 μL, and yet more preferably about 50 μL of the synthetic polymer is added to the polar solvent and metal-organic framework. In some embodiments, the metal-organic framework and the synthetic polymer may form a complex comprising the metal-organic framework in the synthetic polymer. In some embodiments, the metal-organic framework may be dispersed in the synthetic polymer to form the complex. In some embodiments, the solution containing the metal-organic framework, the synthetic polymer, and the polar solvent is mixed. In some embodiments, the mixing includes, but is not limited to, sonication, ultrasonication, hand mixing, blending, stirring, vortexing, the like, and a combination thereof. In a preferred embodiment, the mixing includes sonicating the solution containing the metal-organic framework, the synthetic polymer, and the polar solvent.

In some embodiments, the metal-organic framework has at least 60 percent, preferably at least 75 percent, preferably at least 80 percent, more preferably at least 90 percent, and yet more preferably at least 95 percent exposed polymer-free surfaces, based on a total area of the metal-organic framework. In some embodiments, the synthetic polymer binds the metal-organic framework to the conductive carbon paper. In some embodiments, the synthetic polymer may cover the metal-organic framework in an amount less than 20 percent, preferably less than 15 percent, more preferably less than 10 percent, and preferably less than 5 percent, based on the total area of the metal-organic framework.

After suspension, the metal-organic framework in the synthetic polymer is deposited on the conductive carbon paper that serves as a substrate. Carbon papers are preferred as they possess properties such as high electrical conductivity, mechanical strength, and chemical resistance. In some embodiments, the carbon paper may have a thickness of 0.1 to 0.5 millimeters (mm), preferably 0.2 to 0.4 mm, and more preferably about 0.3 mm. The surface area of the conductive carbon paper is 0.5 to 1.5 square centimeters (cm²), more preferably 0.8 to 1.2 cm², and yet more preferably about 1 cm². Optionally, other substrates, such as carbon cloth, stainless steel, aluminum, nickel, copper, platinum, zinc, tungsten, titanium, and the like may be used as well.

The deposition of the metal-organic framework in the synthetic polymer onto the substrate may be performed by any of the conventional techniques known in the art, such as drop-casting. Drop casting is a technique used to form small coatings on small surfaces. It requires only a small amount of solvent. In this method, a solution is dripped onto the substrate as drops and allowed to dry without spreading. Alternate techniques for depositing the catalyst on the substrate include spray coating, spin coating, dip coating, submersion, dipping, the like, and a combination thereof.

The electrochemical cell further includes the counter electrode and the reference electrode. As used herein, “counter-electrode” is an electrode used in an electrochemical cell for voltametric analysis or other reactions in which an electric current is thought to flow. The outer surface of the counter electrode may include an inert, electrically conducting chemical substance, such as platinum, gold, or carbon. The carbon may be in the form of graphite or glassy carbon, preferably graphite. In one embodiment, the counter electrode may be a wire, a rod, a cylinder, a tube, a scroll, a sheet, a piece of foil, a woven mesh, a perforated sheet, a brush, and the like. In a preferred embodiment, the counter electrode is a rod. The counter electrode material should be sufficiently inert to withstand the chemical conditions in the electrolyte solution, such as acidic or basic pH values, without substantially degrading during the electrochemical reaction. The counter electrode preferably should not leach out any chemical substance that interferes with the electrochemical reaction or might lead to undesirable contamination of either electrode, solution, and/or chemical reaction. In a preferred embodiment, the counter electrode is a graphite rod. As used herein, the term “reference electrode” refers to an electrode with a stable and well-known electrode potential. In some embodiments, the reference electrode may be a standard hydrogen electrode (SHE), standard calomel electrode (SCE), silver-silver chloride (Ag/AgCl) electrode, mercury-mercurous oxide (Hg/HgO) electrode, glass electrode, and any other reference electrode known in the art. In a preferred embodiment, the reference electrode is a saturated silver-silver chloride electrode. The working electrode, the counter electrode, and the reference electrode are in connection with a potentiostat.

The electrochemical cell, comprising the working electrode, the reference electrode, and the counter electrode, is at least partially submerged in an aqueous solution. Preferably, to maintain uniform concentrations and/or temperatures of the aqueous solution, the aqueous solution may be stirred or agitated during the application of a potential from the potentiostat. The stirring or agitating may be done intermittently or continuously. This stirring or agitating may be done by a magnetic stir bar, a stirring rod, an impeller, a shaking platform, a pump, a sonicator, a gas bubbler, or some other device. Preferably, the stirring is done by an impeller or a magnetic stir bar. In some embodiments, the aqueous solution may not be stirred or agitated during the application of the potential from the potentiostat. In some embodiments, the aqueous solution may be sparged and/or flushed with an inert gas, such as nitrogen, before and/or during the application of a potential from the potentiostat. The aqueous solution may include water and an inorganic base. The water may be tap water, distilled water, bi-distilled water, deionized water, deionized distilled water, reverse osmosis water, some other water, and/or a combination thereof. The base may be selected from the group consisting of alkaline earth metal hydroxides, such as beryllium hydroxide (Be(OH)₂), magnesium hydroxide (Mg(OH)₂), strontium hydroxide (Sr(OH)₂), and calcium hydroxide (Ca(OH)₂) and/or alkali metal hydroxides, such as lithium hydroxide (LiOH), sodium hydroxide (NaOH), potassium hydroxide (KOH) and rubidium hydroxide (RbOH), and cesium hydroxide (CsOH). In a preferred embodiment, the base is potassium hydroxide. In a preferred embodiment, the aqueous solution is a basic potassium salt solution.

At step 54, the method 50 includes applying a potential from 1.0 to 2.0 volts versus reversible hydrogen electrode (V vs. RHE), preferably from 1.1 to 1.9 V vs. RHE. The potential may be applied to the electrodes by a battery, such as a battery including one or more electrochemical cells of alkaline, lithium, lithium-ion, nickel-cadmium, nickel metal hydride, zinc-air, silver oxide, and/or carbon-zinc. In another embodiment, the potential may be applied through a potentiostat or some other source of direct current, such as a photovoltaic cell. In one embodiment, a potentiostat may be powered by an AC adaptor plugged into a standard building or home electric utility line. In one embodiment, the potentiostat may connect with a reference electrode in the electrolyte solution. Preferably, the potentiostat can supply a relatively stable voltage and/or potential. For example, in one embodiment, the electrochemical cell is subjected to a voltage that does not vary by more than 5%, preferably by no more than 3%, and preferably by no more than 1.5% of an average value throughout the subjecting. In another embodiment, the voltage may be modulated, such as increased or decreased linearly, applied as pulses, and/or applied with an alternating current. In some embodiments, at least a portion of ions in the aqueous solution may adsorb to and/or at the working electrode.

At step 56, the method 50 includes producing oxygen at the working electrode, preferably in the form of bubbles. In some embodiments, the method may produce oxygen at the working electrode that is not visible to the naked eye.

The working electrode has a current density of 100 to 150 milliamperes per square centimeter (mA cm⁻²), preferably 110 to 130 mA cm⁻², more preferably 115 to 125 mA cm⁻², and yet more preferably about 120 mA cm⁻² at a potential of 1.8 V vs. RHE. In some embodiments, the working electrode has a current density of 18 to 25 mA cm⁻², preferably 20 to 23 mA cm⁻², and more preferably 21 to 23 mA cm⁻², after applying a continuous potential for 16 to 24 hours, preferably for 18 to 22 hours, and more preferably for about 20 hours. As used herein, the term “current density” refers to the amount of current traveling per unit cross-section area.

In some embodiments, the working electrode has a Tafel slope of 40 to 50 millivolts per decade (mV dec⁻¹), preferably 42 to 49 mV dec⁻¹, more preferably 45 to 47 mV dec⁻¹, and yet more preferably about 46.5 mV dec⁻¹. In some embodiments, the working electrode has a double layer capacitance of 1 to 2 millifarads per square centimeter (mF cm⁻²), preferably 1.1 to 1.5 mF cm⁻², more preferably 1.2 to 1.4 mF cm⁻², and yet more preferably about 1.3 mF cm⁻². In some embodiments, the working electrode has a charge transfer resistance of 1 to 3 ohm (Ω), more preferably about 2.0Ω determined from a Nyquist plot. In some embodiments, the Nyquist plot has a secondary semicircle. In some embodiments, the secondary semicircle has a charge transfer resistance of 0.5 to 1.5Ω, more preferably about 1Ω.

FIG. 1B illustrates a process 70 of making the metal-organic framework. The order in which the method 70 is described is not intended to be construed as a limitation, and any number of the described method steps can be combined in any order to implement the method 70. Additionally, individual steps may be removed or skipped from the method 70 without departing from the spirit and scope of the present disclosure.

At step 72, the process 70 includes mixing a cobalt salt, a benzene-1,3,5-tricarboxylic acid (BTC), an amide, and a polar protic acid to form a solution. In some embodiments, the cobalt salt may include, but is not limited to, cobalt (II) fluoride, cobalt (II) chloride, cobalt (II) bromide, cobalt (II) iodide, cobalt (II) nitrate, the like, and a combination thereof. In some embodiments, the cobalt salt is Co(NO₃)₂. In some embodiments, the amide may include, but not limited to, formamide, acetamide, benzamide, dimethylformamide, the like, and a combination thereof. In a preferred embodiment, the amide is N-dimethylformamide (DMF). The cobalt salt, BTC, and amide are mixed in a polar protic solvent. Suitable examples of polar protic solvents include, but are not limited to, water, ethanol, ammonia, hydrofluoric acid (HF), acetic acid, the like, and a combination thereof. In a preferred embodiment, the polar protic acid is acetic acid.

At step 74, the process 70 includes sonicating the solution for 2 to 10 minutes, more preferably 4 to 6 minutes, and yet more preferably 5 minutes. In some embodiments, other modes of agitation, apart from/in combination with sonication, for example, stirring, swirling, mixing, or a combination thereof, may be employed to form the resultant mixture.

At step 76, the process 70 includes heating the solution at a temperature of 150 to 200° C., more preferably 160 to 180° C., and yet more preferably at about 170° C. for 20 to 30 hours, more preferably 23 to 25 hours, and yet more preferably for about 24 hours to form the metal-organic framework. In some embodiments, the heating can be performed using heating appliances such as ovens, microwaves, autoclaves, hot plates, heating mantles and tapes, oil baths, salt baths, sand baths, air baths, hot-tube furnaces, hot-air guns, the like, and a combination thereof.

At step 78, the process 70 includes washing and drying the metal-organic framework. In some embodiments, the metal-organic framework can be washed with ethanol, water, distilled water, the like, and a combination thereof. In a preferred embodiment, the metal-organic framework can be washed using dimethyl formamide (DMF) and dichloromethane (DCM). It is preferred to carry out the drying process in a vacuum to prevent any side reactions on exposure to air.

### EXAMPLES

The following examples demonstrate a method of oxygen evolution. The examples are provided solely for illustration and are not to be construed as limitations of the present disclosure. as many variations thereof are possible without departing from the spirit and scope of the present disclosure.

### Example 1: Materials and Methods

Cobalt nitrate (99.9% purity) and benzene-1,3,5-tricarboxylic acid (H₃BTB) was prepared according to the procedure reported in the literature. Acetic acid (99% purity), methanol (99.9% purity), N,N-dimethylformamide (DMF; 99.8% purity), hexane (95.0% purity), and ethyl acetate (99.0% purity) were purchased from Sigma Aldrich Corporation. NMR solvent CDCl₃ (99.9% purity) was purchased from Cambridge Isotope. All chemicals were used without further purification. Water was double distilled and filtered through a Millipore membrane. Analytical thin layer chromatography (TLC) was performed on pre-coated silica gel 60 F₂₅₄ plates. Visualization on TLC was achieved by the use of UV light (254 nm). Flash column chromatography was undertaken on silica gel (400-630 mesh).

¹H and ¹³C NMR spectra were recorded on a Bruker AM-400 spectrometer using Me₄Si as the internal standard. Powdered X-ray diffraction (PXRD) patterns of the samples were recorded using a Rigaku MiniFlex diffractometer (manufactured by Rigaku, Japan), which was equipped with Cu-Kα radiation. The data were acquired over the 20 range of 5° and 30°. The FTIR spectra of Co-BTB were obtained using a Nicolet 6700 Thermo Scientific instrument (manufactured by ThermoFischer, United States) in the range of 400−4000 inverse centimeter (cm⁻¹) using KBr pellets. Thermogravimetric analysis (TGA) of the samples was performed using a TA Q500 (manufactured by TA instruments, United States). An activated sample of UiO-66-BAT (10 milligrams (mg)) was heated in an alumina pan under airflow (60 milliliters per minute (mL min⁻¹)) with a gradient of 10° C. min⁻¹ in the temperature range of 30-800° C. The BET surface area of the MOFs was calculated by using the Micromeritics ASAP 2020 instrument (manufactured by Micromeritics, United States). The surface morphology of these materials were discerned using a field emission scanning electron microscope (FESEM, LYRA 3 Dual Beam, Tescan, Brno, Czechia), which operated at 30 kilovolts (kV). The FESEM samples were prepared from suspension in ethanol. A Gammray 620 potentiostat (Warminster, UK) was used for electrochemical data collection.

### Example 2: Synthesis of Cobalt Metal Organic Framework (Co-BTB)

The reaction was carried out with a fixed amount of 50 mg of H₃BTB and 75 mg of Co(NO₃)₂ dissolved in 15 mL of N-dimethylformamide (DMF) and 0.5 mL of acetic acid. The solution was kept under sonication for 5 minutes. The solution was then transferred to a Teflon-lined steel autoclave and kept in the oven at 170° C. for 24 hours. After that, the yielded product was filtered, washed with DMF and dichloromethane (DCM), and dried under a vacuum. Co₂O₃ was prepared as control sample by applying the above method without adding the linker (H₃BTB).

### Example 3: Characterization

The Co-MOF (Co-BTB) has been characterized using many techniques of analysis: X-ray diffractometry (XRD), Fourier-transform infrared (FTIR), BET surface area analyzer (N₂, CO₂), and X-ray photoelectron spectroscopy (XPS). Also, the microstructure of the Co-MOF was discerned by scanning electron microscope (SEM) and transmission scanning microscope (TEM).

### Example 4: Electrode Preparation

A dispersion of prepared catalyst, weighing 10 mg, was prepared by mixing it with a solution consisting of 750 μL of isopropanol, 200 μL of deionized water, and 50 μL of Nafion (5% by volume). The solution underwent sonication for a duration of 20 minutes. Subsequently, a volume of 100 μL of the suspension was applied onto a conductive carbon paper with a surface area of 1 square centimeter using the drop-casting technique, followed by air drying at ambient temperature.

### Example 5: Electrochemical Evaluation

The performance evaluation and electrochemical characterizations were conducted using a three-electrode cell. The experimental setup involved the utilization of a saturated silver-silver chloride (Ag/AgCl) electrode as the reference electrode and a graphite rod as the counter electrode. The preparation of the working electrode involved the application of a thin film onto the conductive carbon paper. The electrocatalytic activity and other electrochemical experiments were conducted in a 1 molar (M) KOH aqueous electrolyte, unless otherwise specified. Various standard procedures were employed to acquire the structural, morphological, and compositional data of the samples.

### Results and Discussion

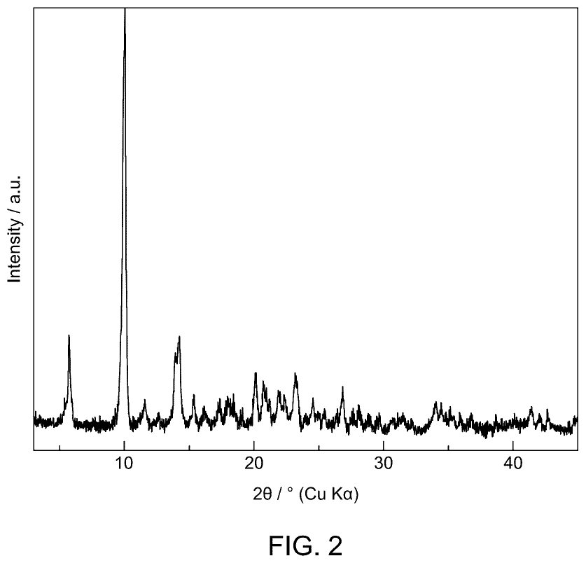

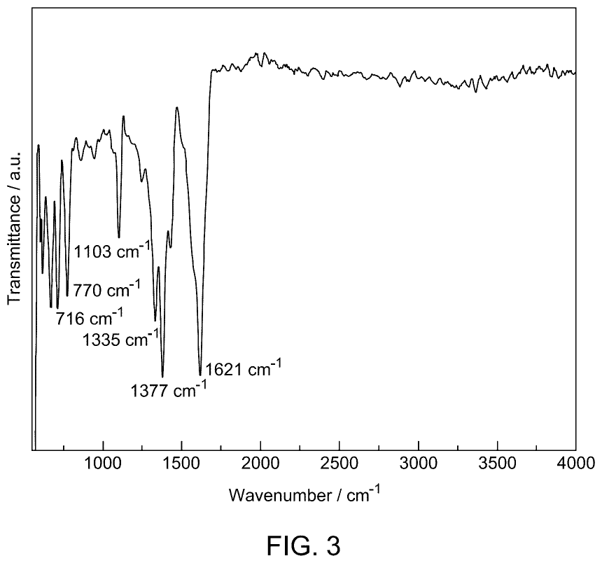

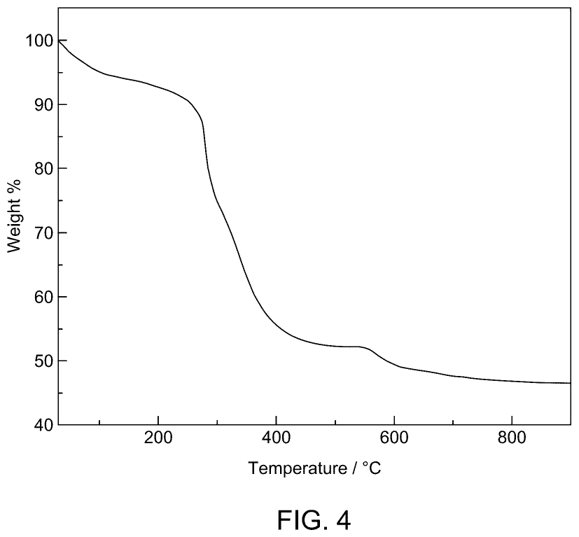

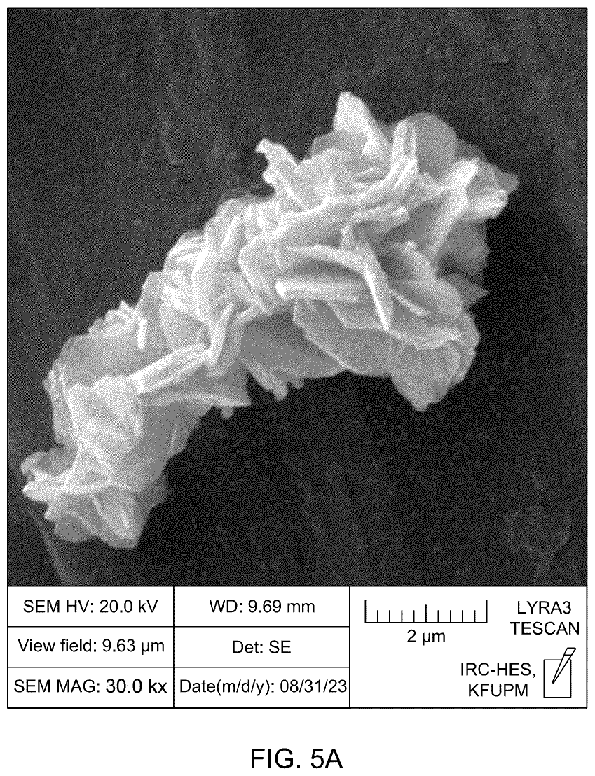

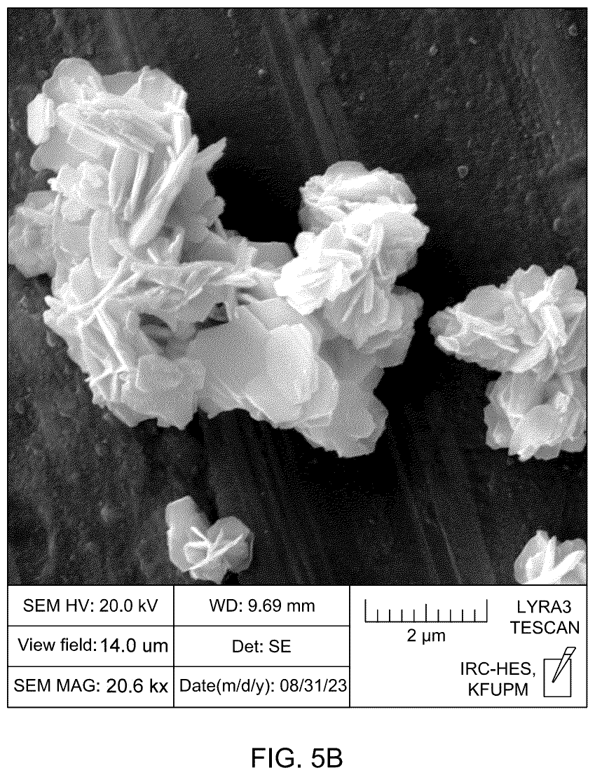

The Co-BTB MOFs were synthesized by slight alteration of the procedure reported in the literature [H. Beitollahi, Q. Van Le, O. K. Farha, M. Shokouhimehr, S. Tajik, F. G. Nejad, K. O. Kirlikovali, H. W. Jang, R. S. Varma, Recent electrochemical applications of metal-organic framework-based materials, Cryst Growth Des. 20 (2020) 7034-7064, which is incorporated herein by reference in its entirety]. The PXRD of the Co-BTB exhibited the characteristic peaks at 20=5.67° and 10.02°, which confirms the crystallinity of the materials (FIG. 2). The Fourier-transform infrared spectrum of Co-BTB was investigated, as seen in FIG. 3. In Co-BTB the peak at 1621 cm⁻¹ corresponds to the coordinated carboxylated groups (COO—). Furthermore, the sharp peak at 1430 cm⁻¹ is assigned to the benzene ring (C═C) of the Co-BTB framework. Thermogravimetric analysis (TGA) of Co-BTB was performed in air with a heating rate of 5° C. min⁻¹ (FIG. 4), in order to investigate the thermal stability of the composite. Co-BTB had a mass loss of 10% between 150° C. and 200° C. This accounts for the loss of trapped water and solvent molecules. There is an abrupt weight loss of 43% around 300° C., due to the decomposition of the framework. The final residue of 47%, in the case of Co-BTB, is the oxides of cobalt. The FESEM image of the microcrystalline Co-BTB shows uniformly distributed flat sheet-like layered structures (FIGS. 5A-5B).

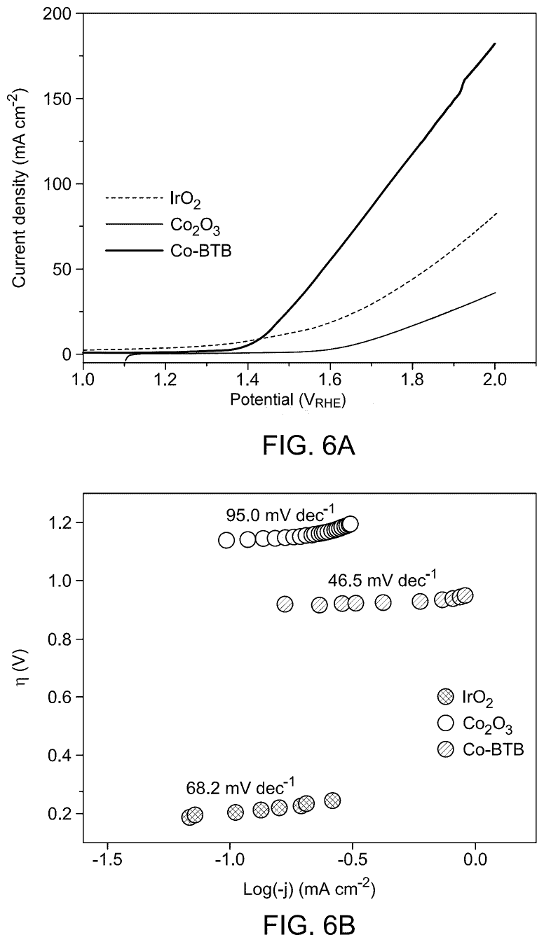

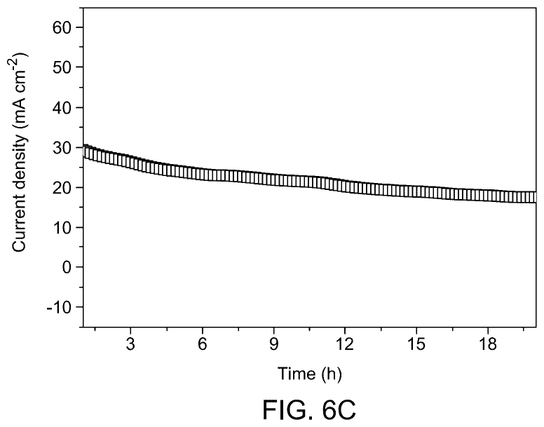

The OER activity of Co-BTB was investigated in a 1 M potassium hydroxide (KOH) solution and compared to the benchmark catalysts of IrO₂ and Co₂O₃ under identical experimental conditions. The OER onset potential of Co-BTB at 1.40 V vs. RHE is depicted in FIG. 6A through linear sweep voltametric (LSV) curves. The potential of the mentioned material was smaller than that of the reference material IrO₂, with a value of 1.45 V vs. RHE, and much smaller than the Co₂O₃. The overpotential experienced at the working electrode follows in a similar vein. The measured current density of 10 mA cm⁻² for the Co-BTB material exhibited a voltage drop of 170 mV which was similar to the potential of IrO₂ (250 mV) and smaller than Co₂O₃ (500 mV), as shown in FIG. 6A. As the potential increases to 1.8 V, the current density is noted to be 120 mA cm⁻², 43 mA cm⁻², and 15 mA cm⁻² for the electrodes Co-BTB, IrO₂, and Co₂O₃, respectively.

The Co-BTB catalyst exhibited a sharp rise in current, surpassing the performance of IrO₂. These findings were consistent with the Tafel plots obtained for both catalysts. The Co-BTB catalyst demonstrated a lower Tafel slope of 46.5 mV dec⁻¹ compared to IrO₂ (68.2 mV dec⁻¹) and Co₂O₃ (95.0 mV dec⁻¹), as shown in FIG. 6B. This indicates that Co-BTB exhibited greater performance in terms of quick oxygen evolution reaction (OER) kinetics compared to IrO₂ and Co₂O₃.

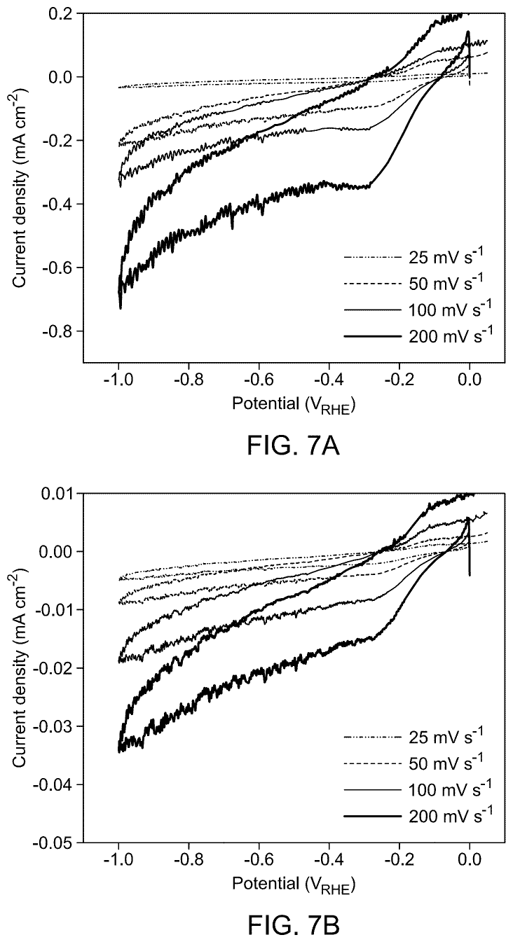

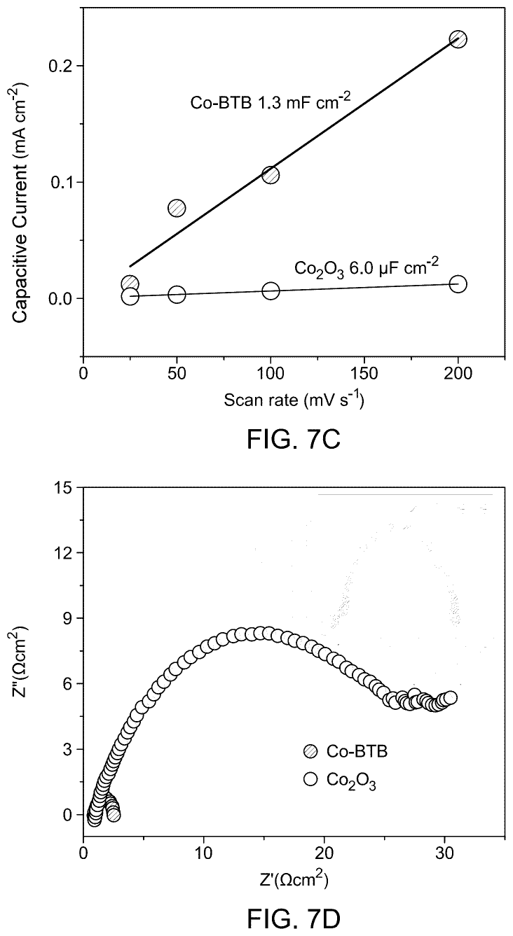

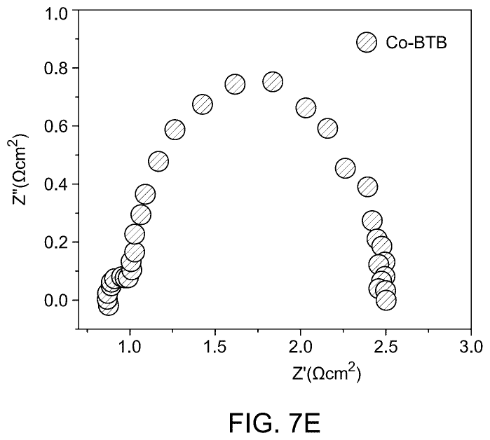

The long-term stability of the electrode Co-BTB, as seen in FIG. 6C, was investigated at 30 mA cm⁻² for 20 hours, and the electrode exhibited good stability for the time during the OER. The investigation of electrical double-layer capacitance is employed to gather data pertaining to the electrochemically active surface area (ECSA) of the electrodes. This approach is chosen due to the anticipated similarity in chemical and physicochemical characteristics of Co-BTB and Co₂O₃. The double-layer capacitance (C_{dl}) is determined by measuring the cyclic voltammograms (CVs) at various scan speeds ranging from 25 to 200 mV s⁻¹. The findings of varying the scan speeds for the Co-BTB and Co₂O₃ are depicted in FIG. 7A and FIG. 7B, respectively. FIG. 7C displays the respective graph illustrating the relationship between capacitive current and scan rate for the Co-BTB and Co₂O₃ electrodes. The capacitance values of the Co-BTB and Co₂O₃ materials were determined to be 1.3 mF cm⁻² and 6.0 μF cm⁻², respectively (FIG. 7C). The correlation between higher Cal and higher ECSA can be attributed to the fact that an increase in ECSA leads to improved electrocatalytic performance for Co-BTB. The utilization of the electrochemical impedance spectroscopic (EIS) approach is employed to examine the electrical resistance and interfacial charge transfer resistance (R_{ct}) that is active between the surface of the electrode and H₂O/OH. The experiments were conducted at overpotentials of 400 in the frequency range of 105-0.01 hertz (Hz), using a sinusoidal perturbation of 10 mV. The Randle circuit was employed for fitting the electrochemical impedance spectroscopy (EIS) data. At the given overpotential the Nyquist plot (FIG. 7D) for Co₂O₃ showed Ret value of 30Ω, while the Co-BTB showed a value of 2.0Ω, demonstrating the high charge transfer rate which also explain the greater OER performance compared to the Co₂O₃. In FIG. 7E of the Nyquist plot of Co-BTB includes a secondary semicircle of R_{ct} of 1.0Ω due to the surface roughness and/or the porosity of the MOF.

Numerous modifications and variations of the present disclosure are possible in light of the above teachings. It is therefore to be understood that within the scope of the appended claims, the disclosure may be practiced otherwise than as specifically described herein.

1: A method of oxygen evolution, comprising:
contacting a working electrode, a counter electrode, and a reference electrode with an aqueous solution,
wherein the working electrode is a metal-organic framework in a synthetic polymer on a conductive carbon paper,
wherein the metal-organic framework comprises cobalt and reacted units of benzene-1,3,5-tricarboxylic acid,
wherein a weight ratio of the cobalt to the reacted units of the benzene-1,3,5-tricarboxylic acid is from 1:1 to 1:5,
wherein the working electrode, the counter electrode, and the reference electrode are in connection with a potentiostat,
applying a potential from 1.0 to 2.0 V vs. RHE; and
producing oxygen at the working electrode.

2: The method of claim 1, wherein the metal-organic framework is in the form of agglomerated hexagonal sheet-like layers.

3: The method of claim 2, wherein the agglomerated hexagonal sheet-like layers are in bunches of 5 to 500 individual hexagonal sheets.

4: The method of claim 3, wherein in the individual hexagonal sheets have the longest dimension of 0.5 to 5 micrometers (μm).

5: The method of claim 1, wherein the metal-organic framework is made by a process comprising:
mixing a cobalt salt, a benzene-1,3,5-tricarboxylic acid, an amide, and a polar protic acid to form a solution;
sonicating the solution for 2 to 10 minutes;
heating the solution at a temperature of 150 to 200° C. for 20 to 30 hours to form the metal-organic framework; and
washing and drying the metal-organic framework.

6: The method of claim 1, wherein the metal-organic framework has a thermal stability of 280 to 320° C., as measured by thermogravimetric analysis (TGA).

7: The method of claim 1, wherein a surface area of the conductive carbon paper is 0.5 to 1.5 square centimeter (cm²).

8: The method of claim 7, wherein a volume of 50 to 150 microliters (μL) of the metal-organic framework in the synthetic polymer in a polar solvent is deposited on the surface area of the conductive carbon paper.

9: The method of claim 8, wherein the metal-organic framework in the synthetic polymer in the polar solvent are drop-cast on the conductive carbon paper.

10: The method of claim 1, wherein the synthetic polymer is a sulfonated tetrafluoroethylene polymer.

11: The method of claim 1, wherein the counter electrode is a graphite rod.

12: The method of claim 1, wherein the reference electrode is a saturated silver-silver chloride electrode.

13: The method of claim 1, wherein the aqueous solution is a basic potassium salt solution.

14: The method of claim 1, wherein the working electrode has a current density of 100 to 150 milliamperes per square centimeter (mA cm⁻²) at a potential of 1.8 V vs. RHE.

15: The method of claim 1, wherein the working electrode has a Tafel slope of 40 to 50 millivolts per decade (mV dec⁻¹).

16: The method of claim 1, wherein the working electrode has a current density of 18 to 25 mA cm⁻² after applying a continuous potential for 16 to 24 hours.

17: The method of claim 1, wherein the working electrode has a double layer capacitance of 1 to 2 millifarads per square centimeter (mF cm⁻²).

18: The method of claim 1, wherein the working electrode has a charge transfer resistance of 1 to 3 ohm (Ω) determined from a Nyquist plot.

19: The method of claim 18, wherein the Nyquist plot has a secondary semicircle.

20: The method of claim 19, wherein the secondary semicircle has a charge transfer resistance of 0.5 to 1.5Ω.
